(19) United States
(12) Patent Application Publication
(10) Pub. No.: US 2007/0235148 A1
(43) Pub. Date: Oct. 11, 2007

(54) Honeycomb-like structure barrier in a body of water

(76) Inventor: Liam Sean Scanlan, Bellevue, WA (US)

Correspondence Address: LIAM SEAN SCANLAN, 13720 SE 58 PL., BELLEVUE, WA, 98006, US

(21) Appl. No.: 11/446,558

(22) Filed: Jun. 5, 2006

Related U.S. Application Data
(60) Provisional application No. 60/771,100, filed on Feb. 6, 2006.

(51) Int. Cl. E06B 9/00

(52) U.S. Cl. 160/129

(57) ABSTRACT

A kit containing a variety of pieces that allows the user to install a honeycomb structure inside a pond or waterway that is both functional and decorative. The kit includes a number of arms that snap together to form a honeycomb of hexagons that are narrow enough to prevent a child's head to fit through, but wide enough for most fish to easily swim through. Installed, the honeycomb rests within a few inches of the surface of the water, above or below it, and is supported by legs which are assembled from parts in the kit and attached to the honeycomb. The honeycomb can be assembled into a shape that matches the shape of the surface shape of almost any pond or waterway.

### RELATED APPLICATIONS

The present application is a continuation-in-part application of United States provisional patent application, serial number US/60/771,100, filed Feb. 2, 2006, for SELF-ASSEMBLED HONEYCOMB STRUCTURE IN POND TO PREVENT DROWNING, by Liam Sean Scanlan, Bellevue, Wash., included by reference herein and for which benefit of the priority date is hereby claimed.

### FIELD OF THE INVENTION

The present invention relates to safety devices and, more particularly, to safety devices that reduce the risk of children drowning in ponds or other bodies of water, and the protection of fish in ponds or other bodies of water.

### BACKGROUND OF THE INVENTION

An exposed body of water allows children or animals to enter that body of water. Risk of drowning or fish destruction exists.

Children drown in garden ponds and waterways close to their home regularly around the world. The UK Department of Public Safety states that a toddler can drown in “as little as three inches of water”. A common way this happens is that the child falls head-first into shallow water, while their body and legs remain outside the water, the child remains face down and doesn't have the strength to push their body up to raise their head above the water. Children are drawn to water, which makes a garden pond, or stream close to where they live, all the more dangerous. Furthermore, most pond drownings in the United States occur in a pond that does not belong to the parents or guardians of the child. The amount of time it takes for a child to drown, or to become injured due to hypoxia, is measured in minutes.

In many parts of the world, housing developments back onto rivers or creeks. Even when such waterways are fenced off, such fences can easily be compromised by for example, a burrowing pet dog, followed by a child who then has access to a water.

The size of this problem is growing for two reasons: The hobby of having decorative fish is growing, so there is a growing number of ponds in the United States. Secondly, people are living longer and remaining more active and healthy than ever before, so more grandchildren are coming in contact with their grandparents' water feature.

In addition to the unmeasurable tragedy of a child losing its life, organizations have concern about the liability associated with someone drowning on their premises, in, for example, a decorative water feature in the grounds of an apartment complex.

Pond and waterway safety devices are what could be described as either Passive or Active. Passive means they work by being in place—like a safety belt in a car—to be effective, they do not need to take any action other than be in place. Active means that they work by taking action in a given situation—like airbags in a motor vehicle—they are usually triggered by an event.

Within the realm of water safety, Passive solutions are nets, grids, fences, or other barriers that stop what is outside the water from getting into the water, at least beyond a few inches from the surface. Active solutions do not physically stop something or someone from getting into the water, but rather, set off a warning to either the child's guardian, or to the predator trying to get into the water. For example, a wristband worn by a child, when wet, triggers an alarm where a parent or guardian can hear it. The vast majority of such water safety devices available in the world today are of the Passive type. The following seven patents relate to the problem of water safety, and each refers to an invention of the Passive type. The solutions associated with the listed patents are either a Soft solution or a Hard solution. A Soft solution is one with a flexible net of wiring structure that prevents entry to the body of water. A Hard solution is any kind of fixed-in-place grid system, much like a shore over a drain, or a metal grill covering a service entrance to a basement, only larger.

2,004,111,978—Garden pond safety grate

DE4136976—Safety net for enclosing garden pool

GB2344515—Garden pond

GB2345634—Pond safety device

GB2376553—Safety device for a pond or swimming pool

WO0214629—garden pond safety grate

DE19650395—Pond, especially a PVC pond with a safety device for preventing children from drowning

Active type solutions are not as popular as Passive ones, mostly because Active solutions are only marginally effective. They are not considered good enough to protect children.

Fences can easily be compromised by a child or animal climbing under or over the fence, rendering them ineffective. In the case of wrist-bands that transmit a signal when the child come into contact with water, there are the risks of dead batteries, alarm being unplugged, absent parents, and any equipment failure.

Are expensive, mostly due to the high labor cost associated with installing them.

Are usually not recyclable. Materials, leftovers and waste end up not being recycled.

Tend to require significant use of tools such as screwdrivers and cutters.

Require a support shelf to be installed inside the pond, having a significant impact on that pond and its contents.

Require significant labor to remove.

Require a perimeter material to be installed to finish the edge of the structure.

Interfere with existing plants, fish and objects installed in the pond, such as fountains, pumps, waterlillies or watergrass.

Are significant engineering projects that, when they need to be removed, impact the pond significantly.

Require significant skill to install.

Take hours or days to install.

Before installation, consist of very large objects, making it difficult to transport.

Require significant planning and measurement, for example, about where the user will need an opening to gain access later, before the installation starts.

Can be installed incorrectly by a novice, because a high level of expertise is required.

Requires significant strength and physical labor to install.

Are difficult to repair or adjust.

Use a lot of materials, particularly materials which are difficult to recycle.

Are aesthetically displeasing.

Usually must be built-to-order.

It is therefore an object of the invention to provide a way to make ponds and waterways safer for children.

It is a further object of the invention to provide a way to protect decorative fish from predators.

It is a further object of the invention to provide a way to protect migratory fish from predators.

It is a further object of the invention to provide a way to make ponds and waterways safer with negligable impact on the environment.

It is a further object of the invention to provide a way to make ponds and waterways safer that is easy for a novice to put into effect.

It is a further object of the invention to provide a way to make ponds and waterways safer that requires a minimal use of tools to put into effect.

It is a further object of the invention to provide a way to make ponds and waterways safer that is packageable in a dense form that is cost-effective for shippers and retailers.

### SUMMARY OF THE INVENTION

In accordance with the present invention, there is provided a kit containing different pieces that allow the user to install a honeycomb-like structure inside their pond or body of water that is both functional and decorative. For the purposes of this document, a waterway is any body of water that contains water. Examples are streams, rivers, creeks, barrels, half-barrels, baths, jacuzzis and tanks. For the purposes of this document, a honeycomb is a structure that resembles the natural multi-hexagonal structure created by bees and other such insects, even though it might not have precisely six equal sides or might not be precisely symmetrical; thus, the general natural form of a honeycomb created by bees is what is meant by the term honeycomb. The term “honeycomb-like structure” is used only when it is required to be precise, such as in the claims section. The kit includes a number of brackets, referred to as arms, that snap together to form a honeycomb of hexagons that are narrow enough to prevent a child's head to fit through, but wide enough for most fish to easily swim through. Installed, this honeycomb rests close to the surface of the pond or waterway. The honeycomb can be assembled into a shape that matches the shape of the pond or waterway. The honeycomb is supported by legs, also assembled by the customer, each of which extends to the floor of the pond or waterway. The leg is attached to the honeycomb via a number of buttresses, three of which attach to each leg. The buttress rests on the leg, and the honeycomb rests on the buttress, thereby transferring the weight of the honeycomb on to the pond floor. Each leg can be assembled to any length between 6 inches and about 3 feet, deeper if the floor of the pond or waterway has a predictablly flat, firm surface. This variable leg depth is achieved by the customer attaching 4 or more 1½″ lengths of leg sections until the depth, at the point of the pond or body of water where the leg stands, is reached. At the base of each leg is attached a foot. The foot snaps together with the bottom of the leg, and has a round smooth base, enabling it to spread the load across a broader area of the floor of the pond or body of water, minimizing potential damage to that floor. The honeycomb can, optionally, be attached to the walls or the perimeter of the pond for extra stability. Together, these pieces form a substantial barrier between what is inside the water and what is outside the water.

### BRIEF DESCRIPTION OF THE DRAWINGS

A complete understanding of the present invention may be obtained by reference to the accompanying drawings, when considered in conjunction with the subsequent, detailed description, in which:

FIG. 10 is a perspective view of an arm component in accordance with the invention;

FIG. 20 is a front detail view of an arm depicted in FIG. 10;

FIG. 30 is a perspective view of a buttress component in accordance with the invention;

FIG. 40 is a front detail view of a buttress depicted in FIG. 30;

FIG. 50 is a perspective view of a leg component in accordance with the invention;

FIG. 60 is a front detail view of a leg depicted in FIG. 50;

FIG. 62 is a front and side view of a leg in accordance with the invention;

FIG. 65 is a top view of a leg in accordance with the invention;

FIG. 70 is a perspective view of a ring component in accordance with the invention;

FIG. 80 is a front detail view of a ring depicted in FIG. 70;

FIG. 90 is a perspective view of a foot component in accordance with the invention;

FIG. 100 is a front detail view of a foot depicted in FIG. 90;

FIG. 110 is a perspective view of an edge component in accordance with the invention;

FIG. 120 is a front detail view of an edge depicted in FIG. 110;

FIG. 130 is a perspective view of a set of four unattached arm pieces before being attached together in accordance with the invention;

FIG. 140 is a perspective view of a set of four arm pieces, with two of them snapped together in accordance with the invention;

FIG. 150 is a perspective view of a set of four arms with three arms snapped together;

FIG. 160 is a perspective view of a set of four arm pieces with four of them snapped together;

FIG. 165 is a top perspective view of a seventeen arm pieces assembled together in accordance with the invention;

FIG. 167 is a top view of a seventeen arm pieces assembled together in accordance with the invention;

FIG. 170 is a bottom perspective view of a pair of legs, both before and after they have been snapped together;

FIG. 175 is a perspective view of a third leg before it is attached to two already assembled leg pieces in accordance with the invention;

FIG. 176 is a top view of a third leg piece before it is attached to two already assembled leg pieces in accordance with the invention;

FIG. 180 is a perspective view of a third leg piece snapped together with first two leg pieces;

FIG. 185 is a perspective view of a three leg pieces fully assembled about to be inserted into a ring piece in accordance with the invention;

FIG. 190 is a top perspective view of a three leg pieces fully assembled and inserted into a ring piece, making a reinforced leg section in accordance with the invention;

FIG. 200 is a perspective view of a set of four reinforced leg sections about to be inserted into one another in accordance with the invention;

FIG. 205 is a top perspective view of a set of four reinforced leg sections inserted into on another in accordance with the invention;

FIG. 210 is a bottom perspective view of a buttress piece before being attached to an assembly of four reinforced leg sections;

FIG. 215 is a bottom perspective view of a buttress piece attached to a set of four reinforced leg sections in accordance with the invention;

FIG. 220 is a top perspective view of a set of three buttress pieces attached to an assembly of four reinforced leg sections in accordance with the invention;

FIG. 225 is a front view of a buttress piece being attached to an arm piece in accordance with the invention;

FIG. 230 is a perspective view of a complete leg assembly about to be snapped into place on the honeycomb in accordance with the invention;

FIG. 240 is a perspective view of a complete leg assembly snapped into place on the honeycomb;

FIG. 245 is a top perspective view of a leg assembly attached to a set of three assembled arm pieces in accordance with the invention;

FIG. 250 is a top perspective view of a set of three edge pieces snapped into place in each of the three different possible ways on the honeycomb in accordance with the invention;

FIG. 255 is a top view of an edge pieces snapped into place in each of the three different possible ways on the honeycomb in accordance with the invention;

FIG. 260 is a front view of a foot piece before it is snapped into place on a completed leg assembly in accordance with the invention; and

FIG. 265 is a front view of a foot piece snapped into place on a completed leg assembly in accordance with the invention.

For purposes of clarity and brevity, like elements and components will bear the same designations and numbering throughout the Figures.

### DESCRIPTION OF THE PREFERRED EMBODIMENT

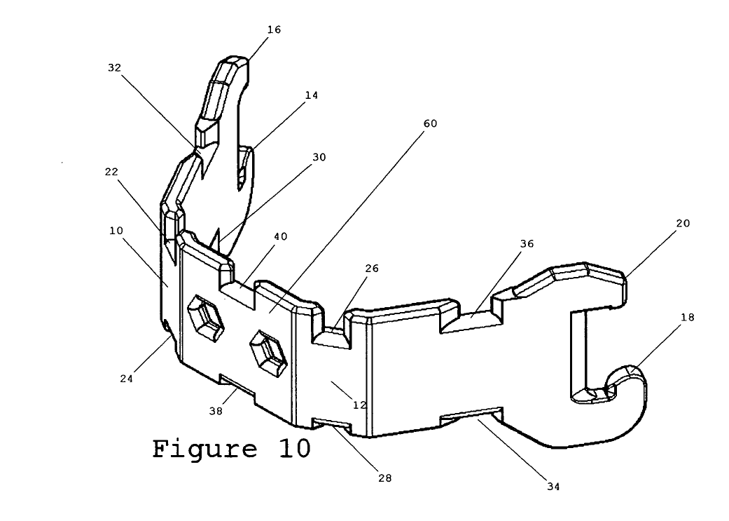

FIG. 10 is a perspective view of an arm 60 component in accordance with the invention. Arm 60 elements are snapped together, as will be explained later in this description, in sufficient numbers to create a honeycomb 116 of a shape and size to match the surface shape and size of a body of water where the invention is to be used. Each arm 60 element is in the shape of, roughly, three adjacent sides of a complete hexagon 110. In other words, if three adjacent sides of a complete 6-sided hexagon 110 were separated from the remaining adjacent three sides of the hexagon 110, the resulting shape would be roughly similar in form to the arm 60 element. The corners where the three sides of the arm 60 meet are chamfered to make the left shoulder 10 and the right shoulder 12. An arm 60 element may be connected to another arm 60 element in one of two ways: the first way is when the right lower hook 18 and the right upper hook 20 of one arm 60 snap onto the left shoulder upper groove 22 and the left shoulder lower groove 24. The second way is when the left lower hook 14 and the left upper hook 16 of one arm 60 snap onto the right shoulder upper groove 26 and the right shoulder lower groove 28, respectively. Both methods are used in the use of this invention, as explained further in this detailed description.

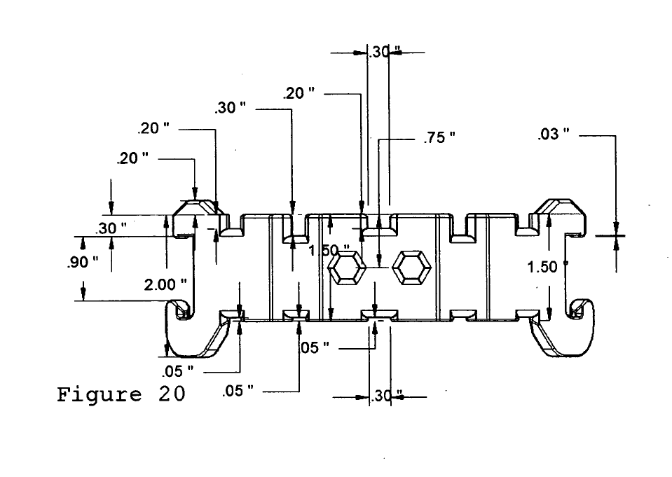

FIG. 20 is a front detail view of a FIG. 20 is a front detail view of the arm 60 depicted in FIG. 10. Note how the arm 60 element is roughly symmetrical, although variations occur in the manufacturing process. The left side of the arm 60 is a mirror of the right side of the arm 60. The arm 60 elements are manufactured in large quantities using common plastic injection molding methods. The material they are made out of is high density polyethylene; also know by its acronym, HDPE. One of the most common uses of HDPE in the United States is in the manufacturing of milk crates and, on occasion, shopping carts. HDPE is used because it is strong, flexible, long-lasting and is food-safe; that is, it can be used to hold food without contaminating the food. It is flexible enough that is can be bent to a considerable degree before it breaks. For all of these reasons, it is the preferred material used to manufacture the parts used in this invention in the context of child safety near water. A stronger, stiffer material can be used if the context of fish protection, where more strength is required, but the structure does not need as much “give” or “bounce” as is preferable when children fall upon it.

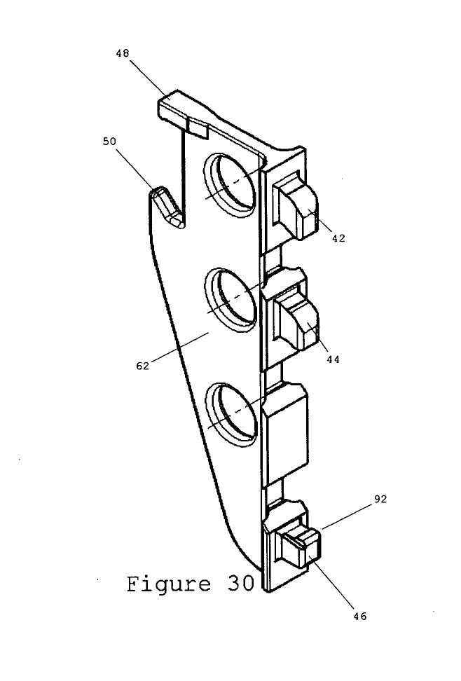

FIG. 30 is a perspective view of a buttress 62 component in accordance with the invention. The buttress 62 functions as the interface between the leg assembly 90 and the honeycomb 116. Three buttress 62 elements are snapped together with the leg assembly 90 by way of three notches on one vertical end of the buttress 62. The three notches, the upper notch 42, the middle notch 44 and the lower notch 46 snap into three correspondingly placed holes on the leg assembly 90. On the opposite vertical side of the buttress 62 is the scoop 50, which, when attached to an arm 60, bears the weight of that arm 60 as it rests on the scoop 50. Above the scoop 50 is the gap into which either a left shoulder 10 or a right shoulder 12 of an arm 60 element is inserted. The arm 60 is held in place by the stabilizer 48, a small protrusion about one inch above the scoop 50. The scoop 50 and the stabilizer 48 together maintain a grip on the arm 60 in a similar way the human hand might maintain a grip on a plastic credit card with the index finger 100 on top and the thumb underneath the credit card. The grip is firm enough to hold the arm 60 in place, let loose enough to allow some flexing when pressure is brought to bear on the honeycomb 116.

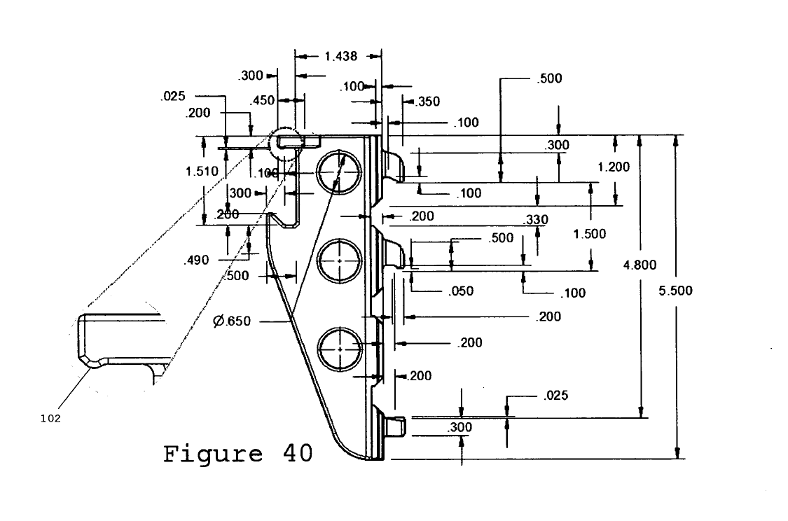

FIG. 40 is a front detail view of a FIG. 40 is a front detail view of the buttress 62 depicted in FIG. 30. The upper notch 42 and the middle notch 44 bear the weight of the honeycomb 116 resting on the buttress 62, by resting their weight on the lower edge 70 of the hole on the leg assembly 90 into which the upper notch 42 and the middle notch 44 elements are inserted. The lower notch 46 is used to hold the buttress 62 in place by way of the upper catch 92 on the lower notch 46.

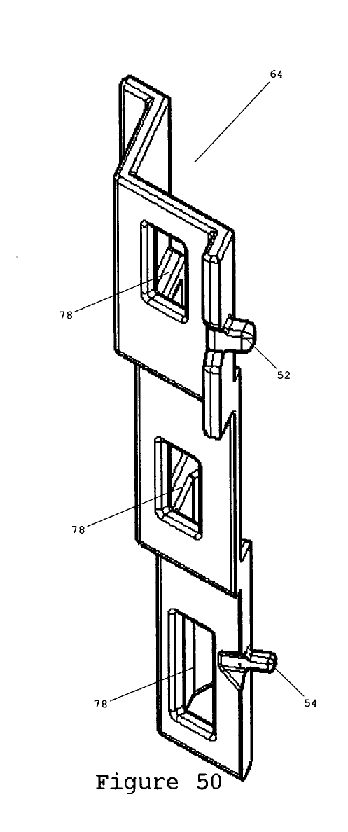

FIG. 50 is a perspective view of a leg 64 component in accordance with the invention. The leg 64 element has three large rectangular holes, two small holes, and two plugs. The two plugs allow it to connect to another leg 64 element, as described in more detail later in this detailed description section. The leg 64 element is made up of three thin, roughly v-shaped walls of plastic, called the upper section 94, the mid section 96 and the lower section 98.

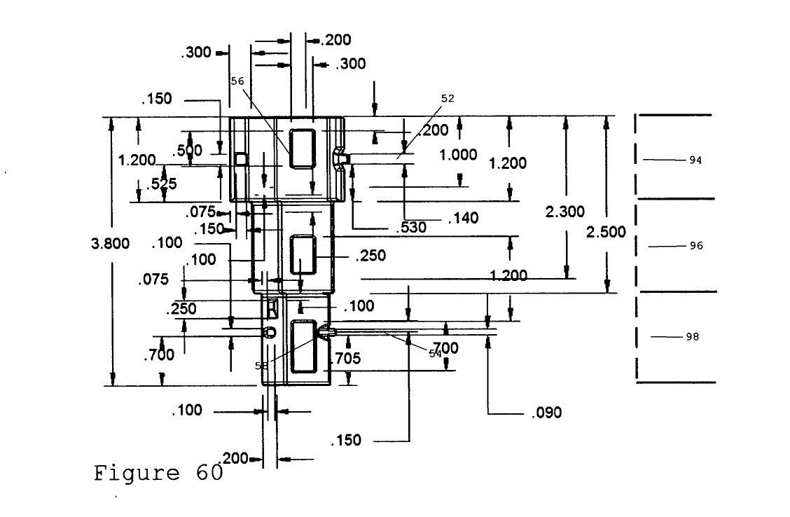

FIG. 60 is a front detail view of the leg 64 element depicted in FIG. 50. The leg 64 element has three sections: the upper section 94, the mid section 96 and the lower section 98. Each section has a rectangular leg hole 78 on one side, and all three rectangular holes face the same direction, as can be seen in FIG. 50. The mid section 96 is narrower than the upper section 94, and the lower section 98 is narrower than the mid section 96. This facilitates the insertion of assembled leg 64 elements into one another, described later in this detailed description section. Note the relative position of the thick plug 52 and its corresponding thick socket 56, into which the thick plug 52 will be inserted during assembly. Note also the position of the thin plug 54 and its corresponding thin socket 58, into which the thin plug 54 is inserted during assembly.

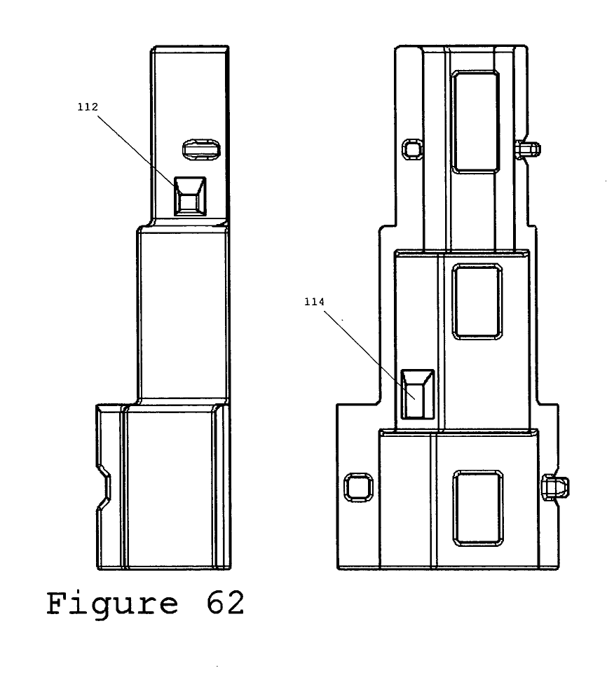

FIG. 62 is a front and side view of the leg 64 element in accordance with the invention. The knoll 112 is a small raised area of the leg 64. The recess 114 is an indentation on the inside of the leg 64 element into which the knoll 112 fits. The precise functioning of both these elements is described later in this detailed description.

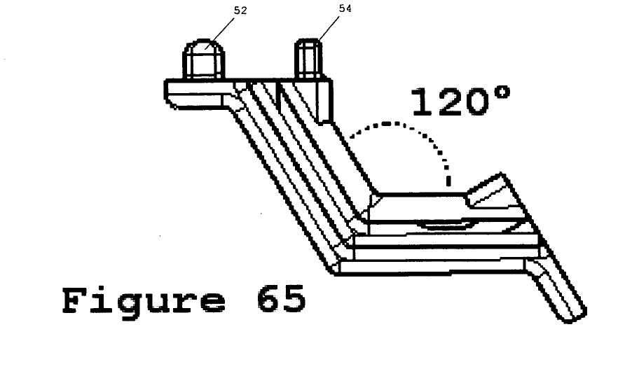

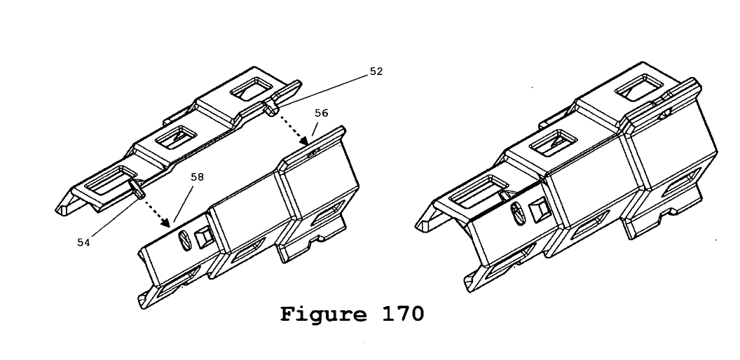

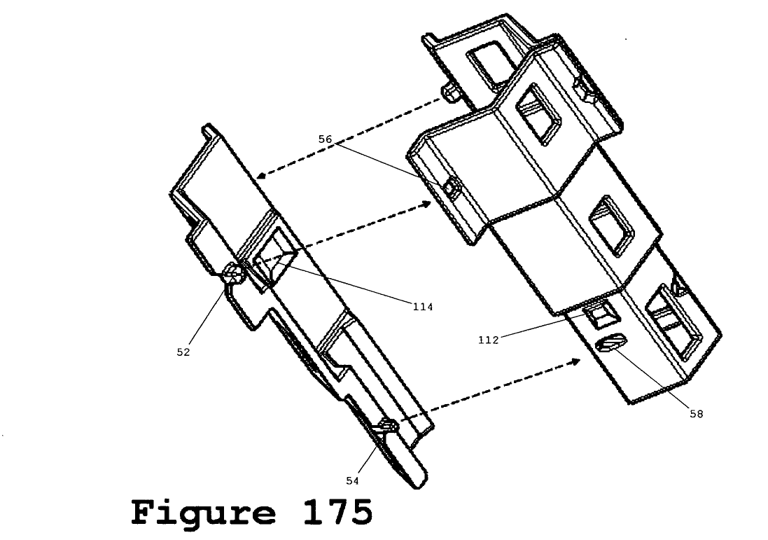

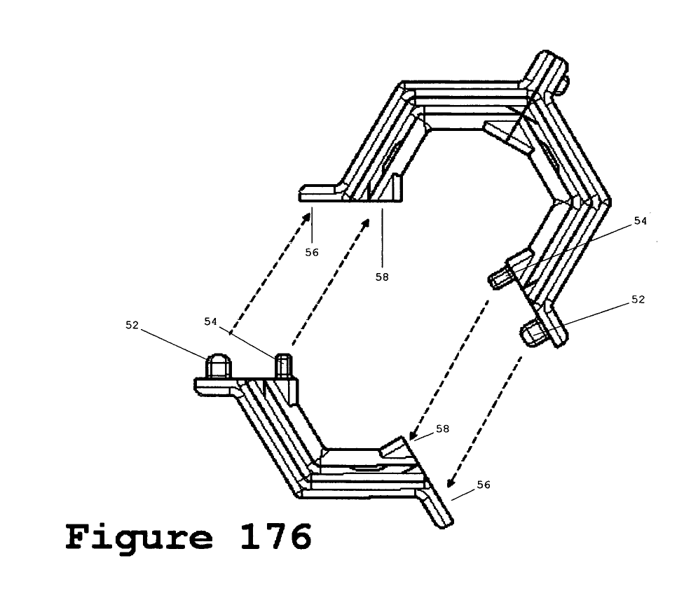

FIG. 65 is a top view of the leg 64 element in accordance with the invention. Viewed from the top, the 120 degree angle can be seen; a single leg 64 element makes up exactly one third of the circular distance around a complete leg assembly 90, that is, one third of a full 360 degrees, illustrated from the same top view in detail in FIG. 176. See also references to FIG. 170 and FIG. 175, below, for details of how three leg 64 elements are snapped together.

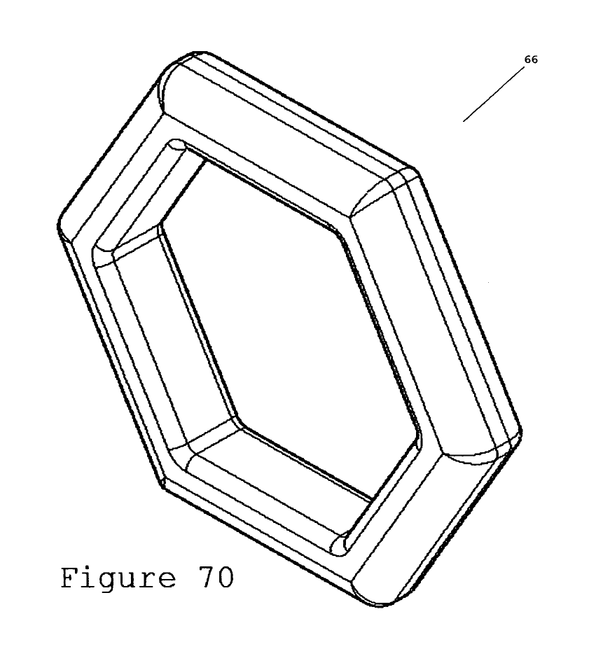

FIG. 70 is a perspective view of a ring 66 component in accordance with the invention. The ring 66 element is a hollowed-out hexagonal element of plastic with edges smoothed to make it both easier to handle and also present no sharp surfaces upon which fish or other life might be damaged when brought in contact with the leg assembly 90 where the invention is being used. The ring 66 element performs the function of holding each set of three assembled leg 64 elements together. For every one ring 66, there are therefore, three leg 64 elements.

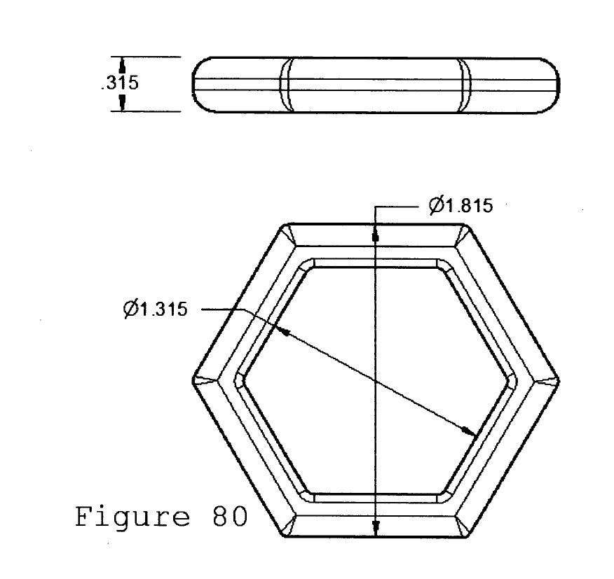

FIG. 80 is a front detail view of the ring 66 depicted in FIG. 70. The edges of the ring 66 element are smooth on the outside. Although it is essentially hexagonally shaped, the ring 66 is a single, unbroken element of high density polyethylene (HDPE). Because of this, each three assembled leg 64 elements only have to be held in place long enough to be inserted into the ring 66 element; a process described in detail below.

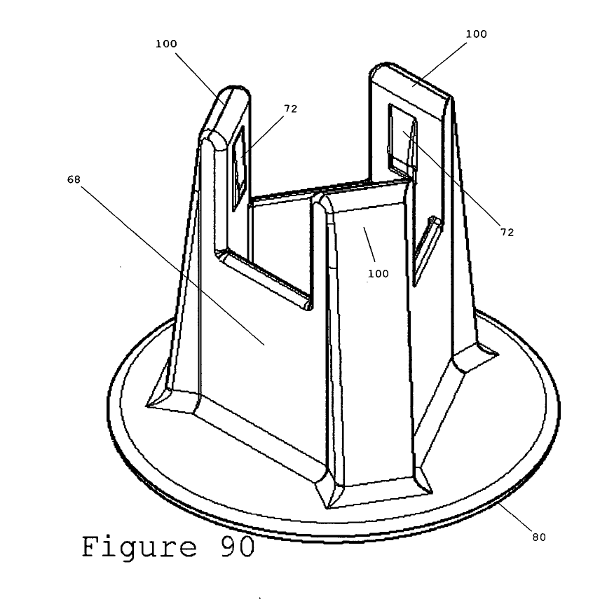

FIG. 90 is a perspective view of a foot 68 component in accordance with the invention. The foot 68 element serves two functions. One, it adds structural rigidity to the lowermost leg 64 elements by wrapping around them as a single element of plastic. More importantly the foot base 80 serves as a smooth contact surface between the load bearing leg assembly 90 and the pond floor. Its smooth surface is less likely to puncture the lining of a pond or other body of water because the load is spread over a greater area than would be the case if the leg assembly 90 sat directly on the pond floor.

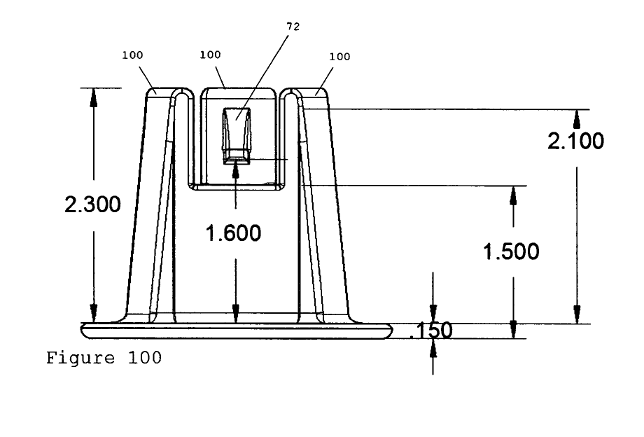

FIG. 100 is a front detail view of the foot 68 depicted in FIG. 90. Each finger 100 on the foot 68 element has a foot notch 72 protruding from it, facing the inside of the foot 68 element. Each of these notches matches up with a corresponding leg 64 hole on the mid section 96 of the lowest leg 64 inserted into the foot 68. The foot notch 72 elements hold the leg assembly 90 in place firmly enough to remain attached to the leg assembly 90, but may be removed by applying moderate force.

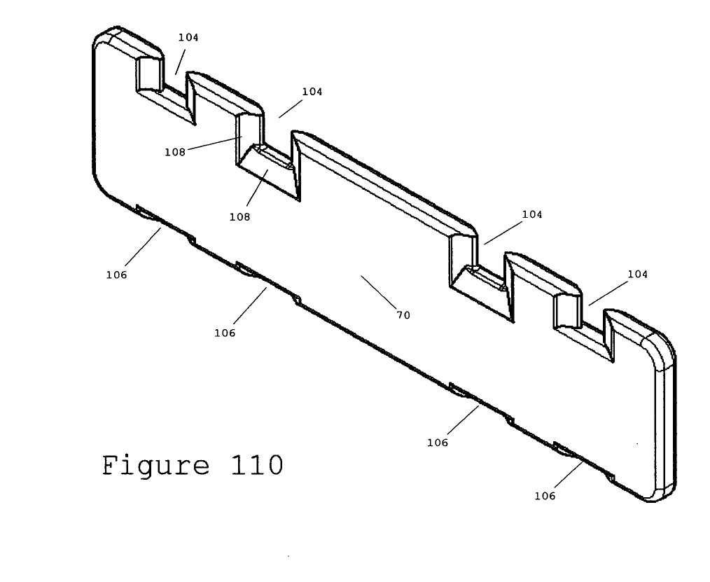

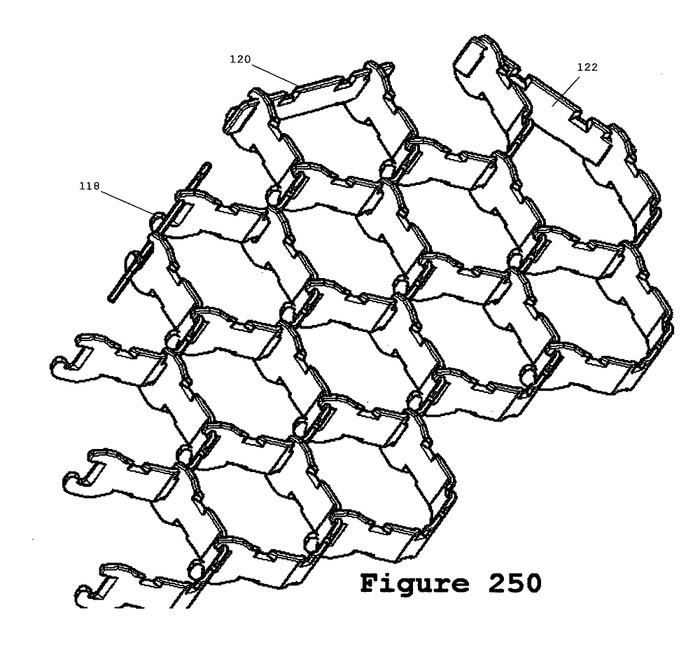

FIG. 110 is a perspective view of an edge 70 component in accordance with the invention. When installed within the invention, the larger grooves on the edge 70 element, that is, the four instances of the edge upper groove 104, face upwards; the side with the smaller grooves face downward. This orientation is also illustrated in FIG. 250, described in detail below, where the edge 70 element is connected to the arm 60 element in three different ways.

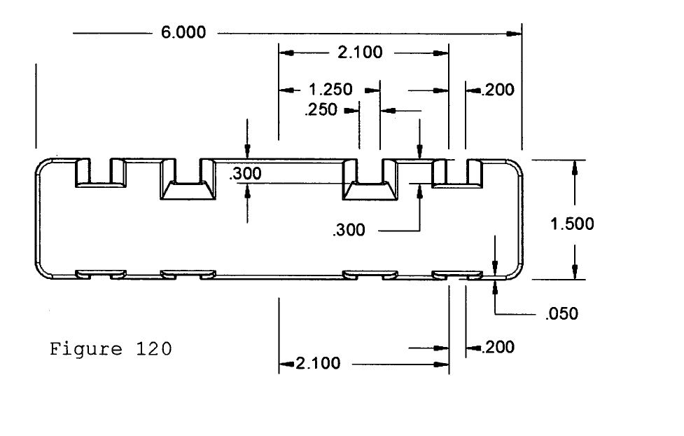

FIG. 120 is a front detail view of a FIG. 120 is a front detail view of the edge 70 depicted in FIG. 110. Here, the four instances of the edge upper groove 104 and the four instances of the edge lower groove 106 can be clearly seen. The beveling 108 on the grooves is provided to make it easier for the user of the invention to snap the edge 70 element together with the arm 60 element. Just like a door latch has a beveled edge 70 to enable the latch to slide into the hole for the latch, the click into place.

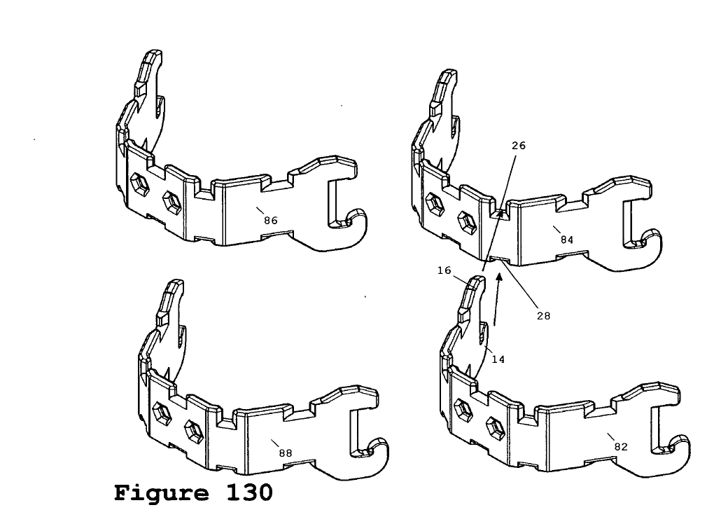

FIG. 130 is a perspective view of a set of four unattached arm 60 elements before being attached together in accordance with the invention. The left shoulder 10 is a narrow vertical wall of the arm 60, which contains the left shoulder lower groove 24 and the left shoulder upper groove 22. The right shoulder 12 is a narrow vertical wall of the arm 60, which contains the right shoulder lower groove 28 and the right shoulder upper groove 26. To connect two arm 60 elements together, the left lower hook 14 of arm-a 82 is held under the right shoulder lower groove 28 on arm-b 84. Next, the left upper hook 16 of arm-a 82 is pushed into the right shoulder upper groove 26 on arm-b 84. This results in the two elements snapping together, and will stay in place unless pressure is applied to separate the two arms, taking the assembly steps in reverse.

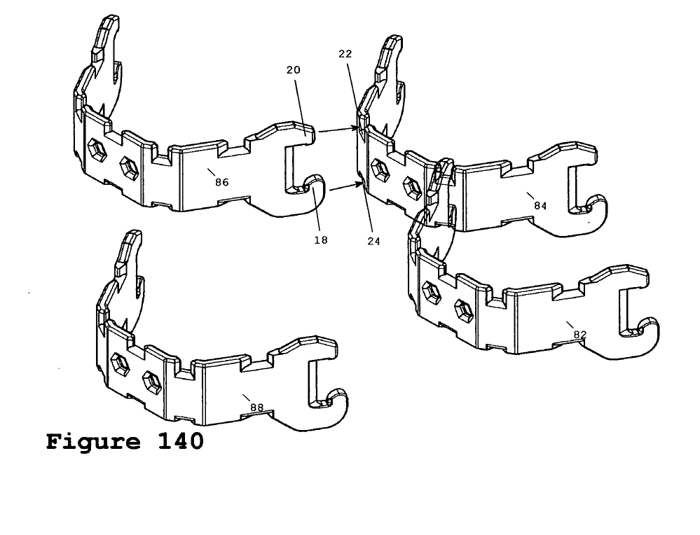

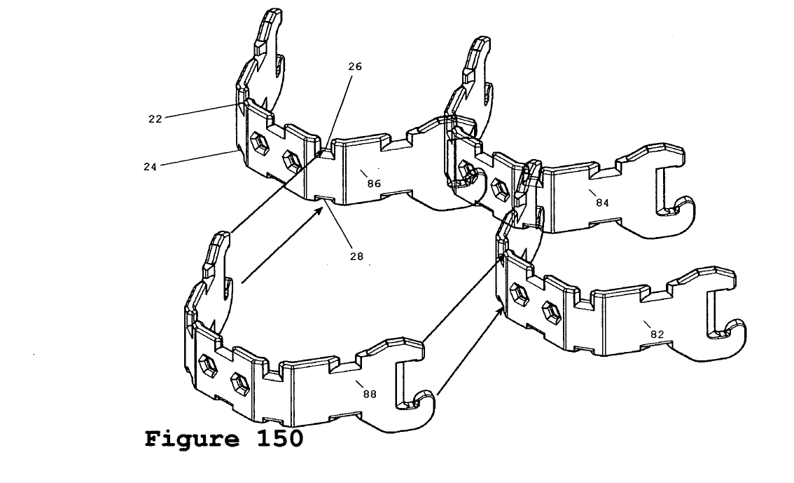

FIG. 140 is a perspective view of a set of four arm 60 elements, with two of them snapped together in accordance with the invention. The right lower hook 18 on arm-c 86 is held under the left shoulder lower groove 24 of arm-b 84. Next, the right upper hook 20 is pushed into the left shoulder upper groove 22 on arm-b 84. Again, this will result in a noticeable “snapping” into place. At this point, three arm 60 elements are assembled together, as can be seen in FIG. 150.

FIG. 150 is a perspective view of a set of four arm 60 elements with three of the arm 60 elements snapped together in accordance with the invention. To connect arm-d 88 with the assembly of arm-a 82, arm-b 84 and arm-c 86, hold the right lower hook 18 on arm-d 88 under the left shoulder lower groove 24 of arm-a 82, and hold the left lower hook 14 on arm-d 88 under the right shoulder lower groove 28 of arm-c 86. Next, push the left upper hook 16 of arm-d 88 over the right shoulder upper groove 26 of arm-c 86 and push the right upper hook 20 of arm-d 88 over the left shoulder upper groove 22 of arm-a 82.

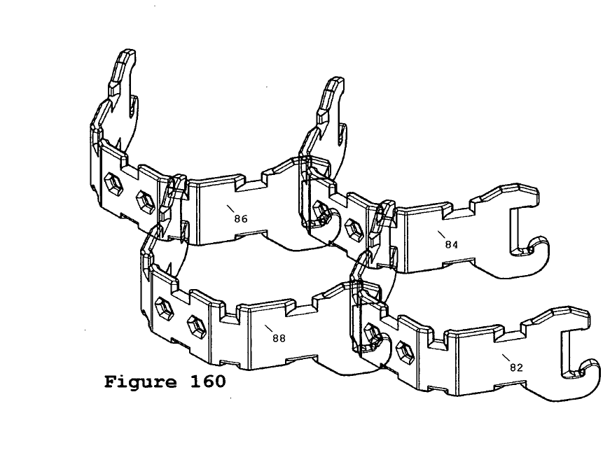

FIG. 160 is a perspective view of a set of four arm 60 elements with four of them snapped together in accordance with the invention. Four assembled arm 60 elements make the first rough hexagon 110 shape in the honeycomb 116. The user of the invention will proceed to add more arm 60 elements such that the honeycomb 116 roughly matches the surface shape of the user's pond or waterway. Just as a person might set tiles on the floor of an odd-shaped room, having many small elements to work with allows them to create a shape that matches the shape of the floor surface. With this invention, it is not necessary to cut any elements. This is because, as long as the honeycomb 116 comes to within a few inches of the edge 70 of the pond or body of water, the function of the invention has been achieved. That is, there remains no space wide enough for a child's head to fit through between the honeycomb 116 and the edge 70 of the pond or waterway.

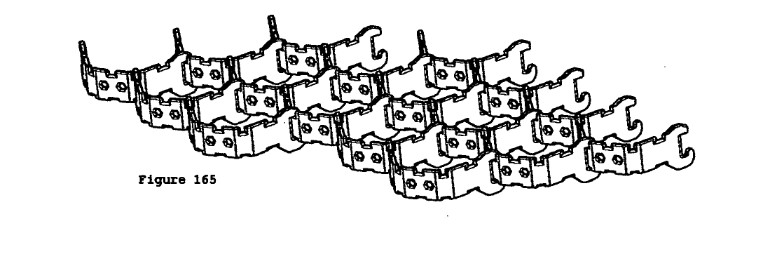

FIG. 165 is a top perspective view of seventeen arm 60 elements assembled together in accordance with the invention. Note the orientation of the arm 60 elements; the larger hooks are on the lower side of the honeycomb 116. This is because the central way the invention works is to support weight brought to bear on the top of the honeycomb 116, pushing the honeycomb 116 downwards. This downward pressure puts the bulk of the pressure on the left lower hook 14 and the right lower hook 18 more than anywhere else on the honeycomb 116. If downward pressure on the honeycomb 116 is increased to a level above its design capacity, the left lower hook 14 and the right lower hook 18 will, eventually, bend, fall out of place and the honeycomb 116 structure will fail. When a left lower hook 14 or a right lower hook 18 is bent enough for an arm 60 to become disconnected from another arm 60 in this way, the structural integrity of the arm 60 element with the bent left lower hook 14 or the right lower hook 18 is considered compromised, and the damaged arm 60 element should be replaced by the user of the invention.

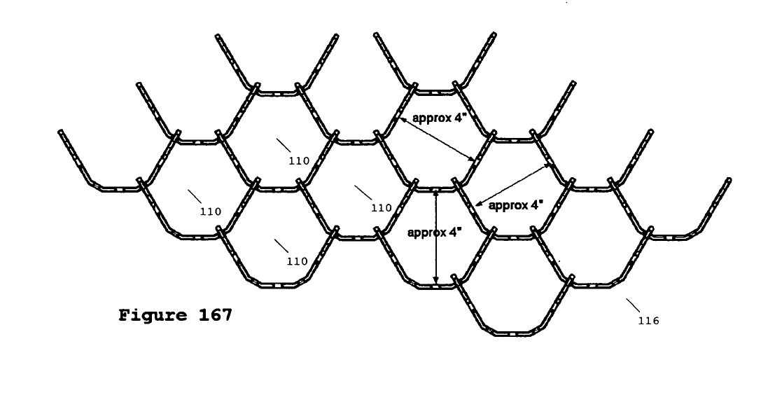

FIG. 167 is a top view of seventeen arm 60 elements assembled together in accordance with the invention. This top view illustrates the shape of each hexagon 110 within the honeycomb 116. Note the width of each such hexagon 110. Although all six sides of the hexagon 110 are not identical, and it could also be said, there are more than six sides if you include the left shoulder 10 and the right shoulder 12, the essential strength and economic use of material inherent in a honeycomb 116 structure is exploited. The wall-to-wall distance of each hexagon 110 is approximately 4 inches.

FIG. 170 is a perspective view of a pair of leg 64 elements being snapped together in accordance with the invention. This is an illustration of the first step in the 3-step manual process to make a leg section 74. That first step is to attach two leg 64 elements together by aligning the thick plug 52 and thin plug 54 on one leg 64 element with the thick socket 56 and thin socket 58, respectively, on the other leg 64 element.

FIG. 175 is a perspective view of a third leg 64 element before it is attached to two already assembled leg 64 elements in accordance with the invention. This is an illustration of the third leg 64 element being attached to the already attached first two leg 64 elements just described. The thick plug 52 and thin plug 54 on the third leg 64 element is inserted into the available thick socket 56 and thin socket 58, respectively. As this is done, the thick socket 56 and thin socket 58 of this third leg 64 element will align very closely with the thick plug 52 and thin plug 54 of the already assembled leg 64 elements. This is the second step in the process of assembling an leg section 74. Note the recess 114 on the inside of the leg 64 element and the knoll 112 on the outside of the leg section 74. The function of the knoll 112 and the recess 114 are described later in this detailed description.

FIG. 176 is a top view of what is illustrated in FIG. 175, a third leg 64 element before it is attached to two already assembled leg 64 elements in accordance with the invention. This view illustrates the relative position of two already assembled leg 64 elements in relation to the third, about to be added leg 64 element.

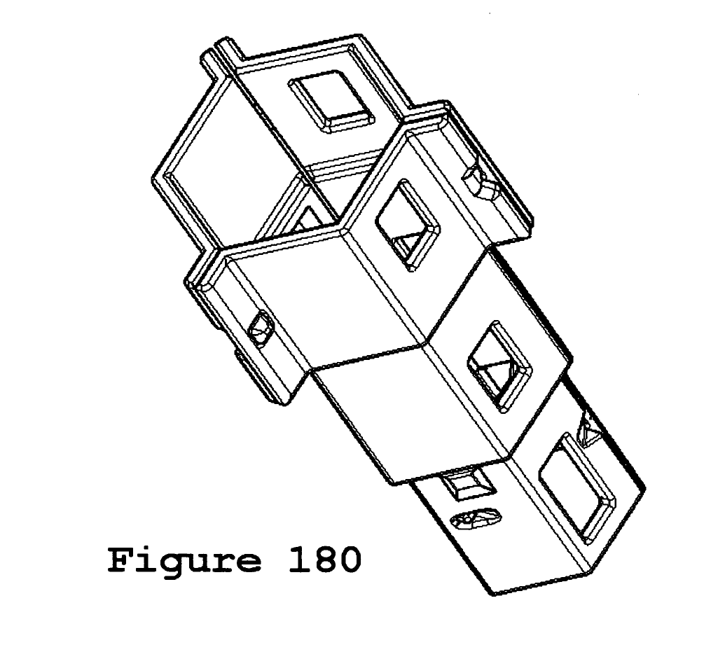

FIG. 180 is a perspective view of a third leg 64 element snapped together with the first two leg 64 elements in accordance with the invention. This illustrates the second step in the 3-step manual process of making a leg section 74.

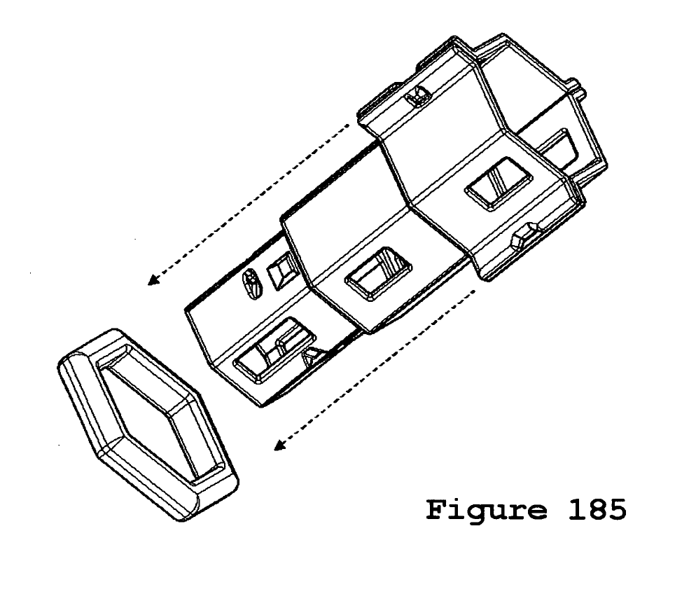

FIG. 185 is a top perspective view of three leg 64 elements fully assembled about to be inserted into a ring 66 element in accordance with the invention. This illustrates the third step in in the 3-step manual process of making a leg section 74. The leg section 74 is simply slid into the ring 66 as far as it will go. This makes one complete reinforced leg section 76.

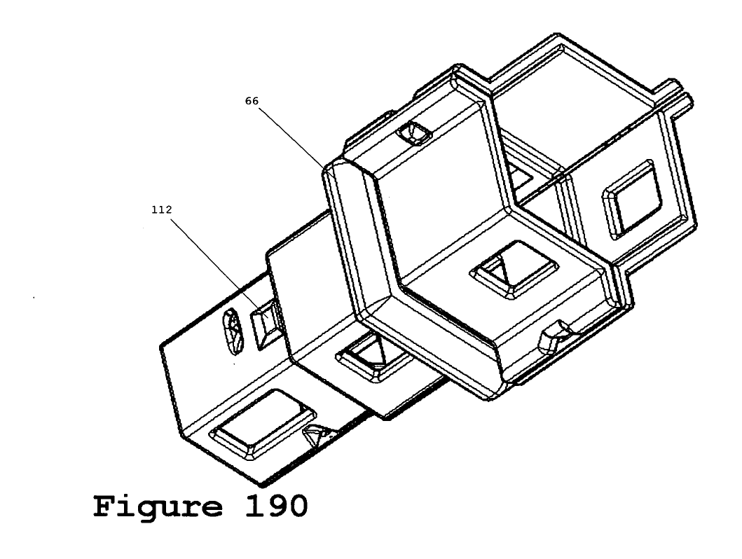

FIG. 190 is a top perspective view of a three leg 64 elements fully assembled and inserted into a ring 66 element, making a reinforced leg section 76 in accordance with the invention. Note the position of the ring 66 element. The ring 66 element wraps around the leg section 74 moderately tightly, and serves the purpose of holding the three leg 64 elements together. The three leg 64 elements cannot be disassembled from one another until the ring 66 is first removed. Note that there are now three knolls on the outside of the reinforced leg section 76; each on one of the three leg 64 elements in the assembly. Although the reinforced leg section 76 illustrated in FIG. 190 could have been manufactured as a single piece, the four-piece assembly accommodates repeated freezing and melting of water in the center of the reinforced leg section 76. In other words, as water inside the usually submerged invention freezes solid when the temperature drops enough, and that ice expands as ice does by 6% when frozen, the three leg 64 elements have enough room to expand. When the ice melts, they move back to their original position. A solid, hollow leg 64, on the other hand, may fracture during the process of such repeated freezing and melting.

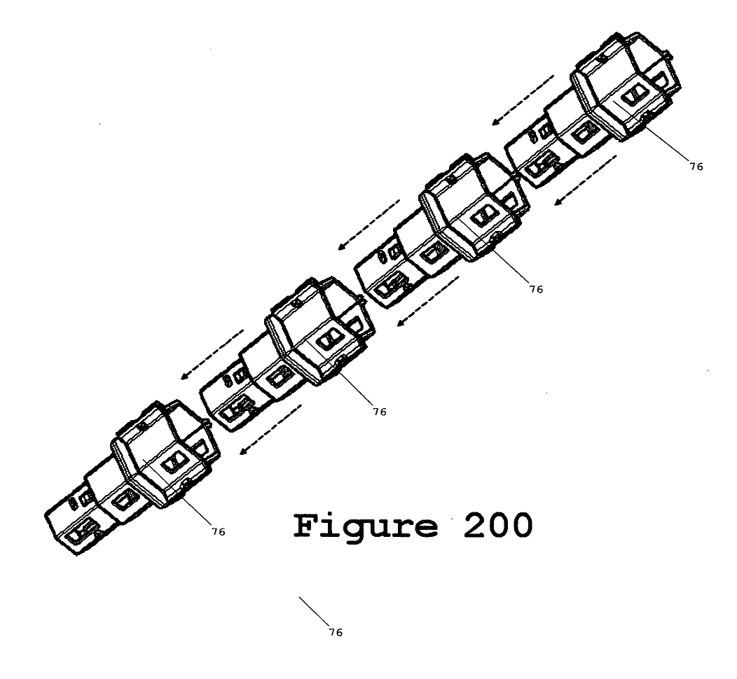

FIG. 200 is a perspective view of a set of four reinforced leg 64 sections about to be snapped together in accordance with the invention. Reinforced leg 64 sections are inserted into one another. Note the position of the knoll 112 and the recess 114, described in detail later in this detailed description.

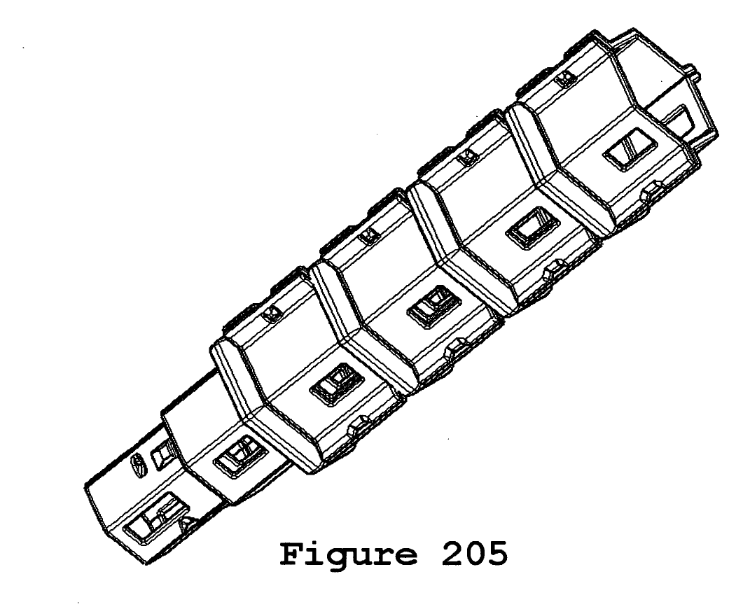

FIG. 205 is a top perspective view of a set of four reinforced leg 64 sections inserted into on another in accordance with the invention. As each reinforced leg section 76 is inserted into another one, the three knolls on the outside snap into the three recesses on the inside of the reinforced leg section 76 into which it is being inserted. Each knoll 112 is bevelled on one side to require only a moderate amount of effort to slide into the respective recess 114, but to require significant effort to remove. This is because, as the completed leg section 74 is standing inside the pond or body of water, the assembly should not easily disassemble itself. In addition, the inserted reinforced leg assembly 90 has the effect of “pushing out” the elements of the reinforced leg assembly 90 into which it is inserted. This has the effect of tightening the grip of the ring 66 element around the reinforced leg assembly 90 slightly, making each section a little more rigid and less likely to disassemble itself when in operation. This extra tightness also makes it difficult for a meddling child to disassemble the leg 64, making the purpose of the invention more difficult to defeat. A single reinforced leg section 76 can be removed with force, but normally, only by first sliding the ring 66 from the end of it, and then letting the leg 64 elements come apart. This means that first, the foot 68 element, if attached, must be removed. All this serves as an obstacle to accidental disassembly, or disassembly by a child.

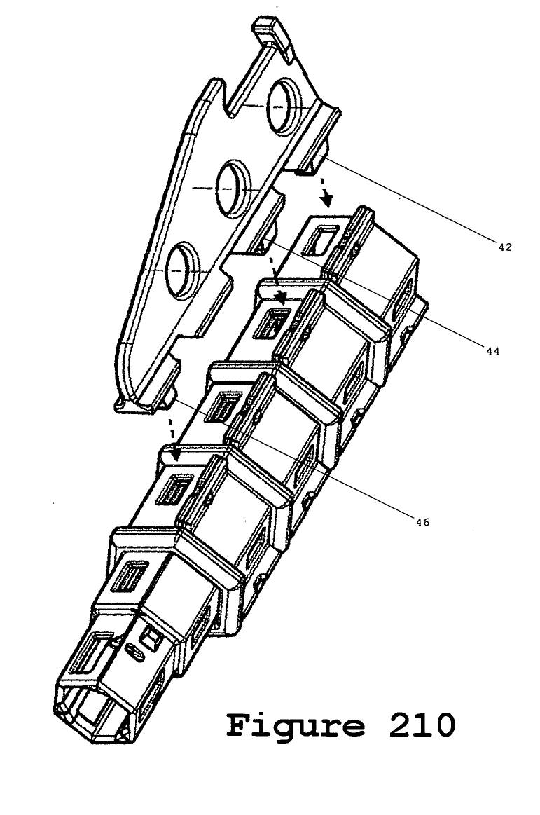

FIG. 210 is a bottom perspective view of a buttress 62 being attached to an assembly of reinforced leg 64 sections in accordance with the invention. Note the position of the upper notch 42, the middle notch 44 and the lower notch 46, which line up directly with the rectangular holes on the top, second from top, and fourth from top holes on the complete leg assembly 90.

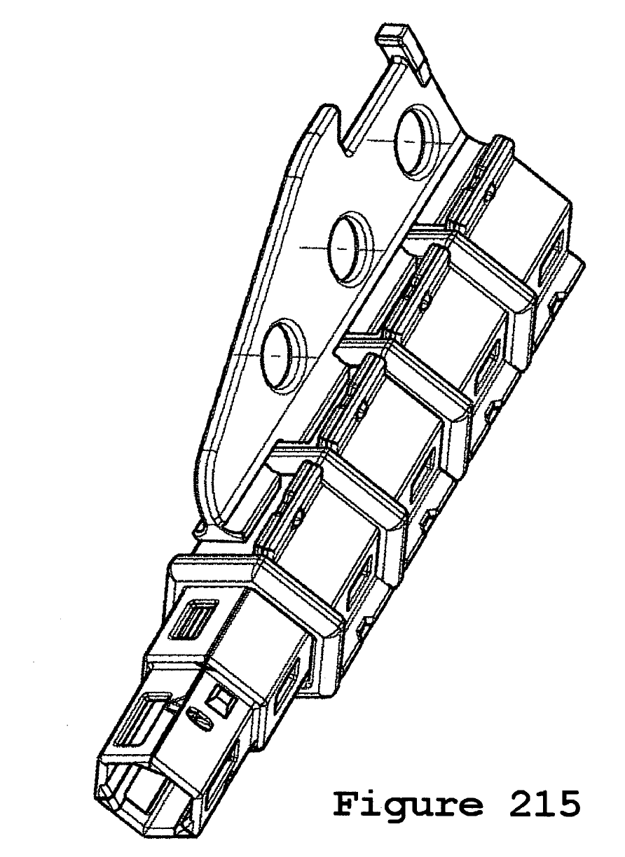

FIG. 215 is a bottom perspective view of a buttress 62 element attached to a set of four reinforced leg 64 sections. The upper notch 42, the middle notch 44 and the lower notch 46 are inserted into their respective holes on the complete leg assembly 90.

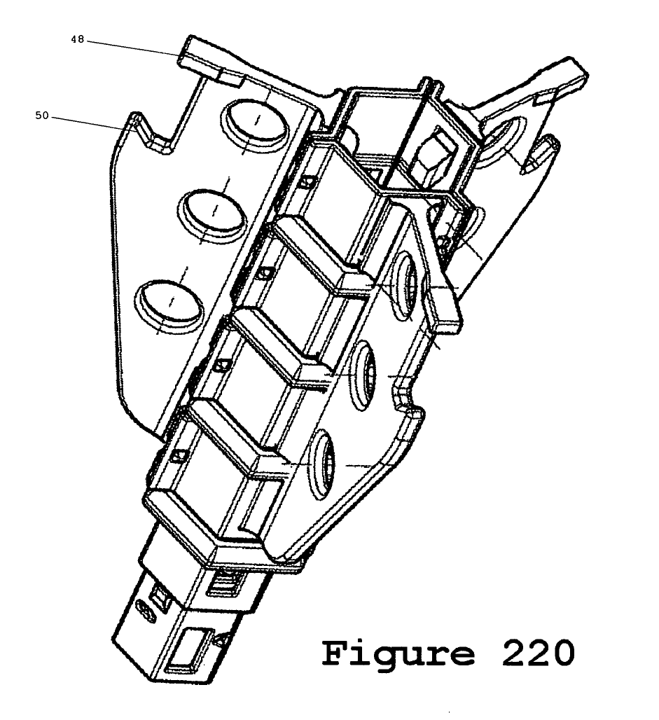

FIG. 220 is a top perspective view of a set of three buttress 62 elements attached to an assembly of four reinforced leg section 76 elements in accordance with the invention.

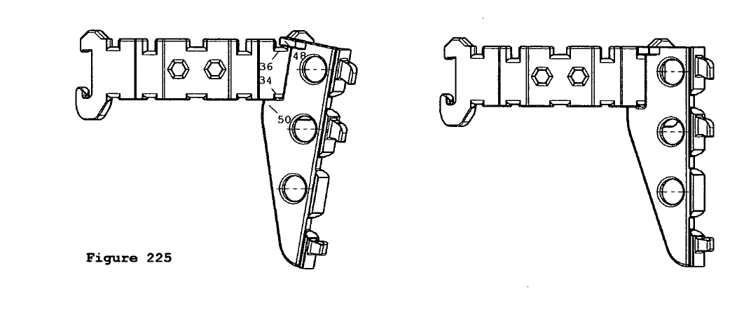

FIG. 225 is a front view of a buttress 62 element being attached to an arm 60 element in accordance with the invention. Before proceeding with the attachment of the leg assembly 90 to the three already assembled arm 60 elements, this is how every arm 60 connects to a buttress 62. To connect a buttress 62 to an arm 60, the scoop 50 on the buttress 62 is placed underneath one of three possible elements of the arm 60: the left hook lower groove 30, the right hook lower groove 34 or the spine lower groove 38. In FIG. 225, the scoop 50 on the buttress 62 is placed under the right hook lower groove 34, illustrated on the left hand side of the FIG. 225. With the scoop 50 snugly held under the right hook lower groove 34, the buttress 62 is righted so that the stabilizer 48 is pushed into place over the right hook upper groove 36. The element snaps into place with minimal effort. A stabilizer lip 102 on the underside of the stabilizer 48 eases the contact between the stabilizer 48 and the right hook upper groove 36 during the process of pushing the stabilizer 48 into place on the arm 60.

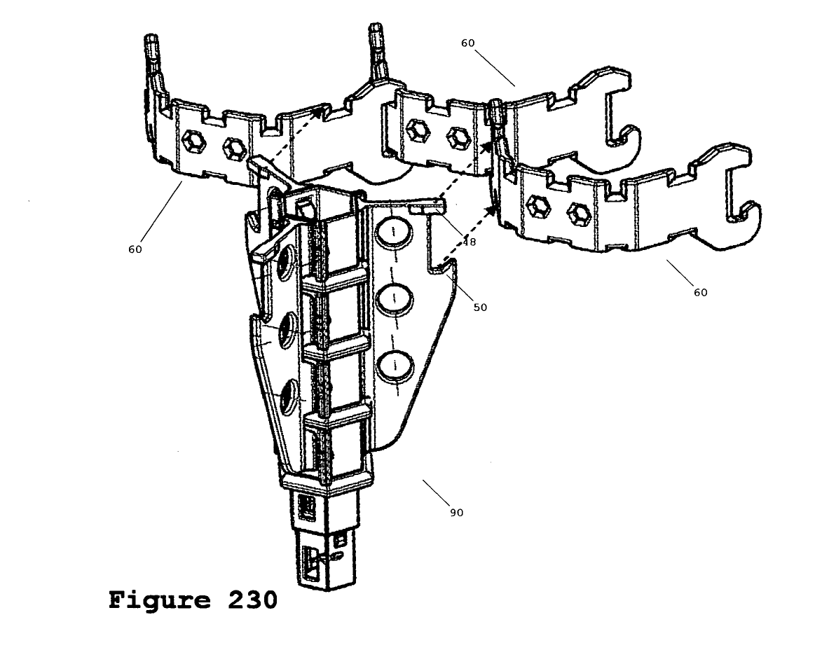

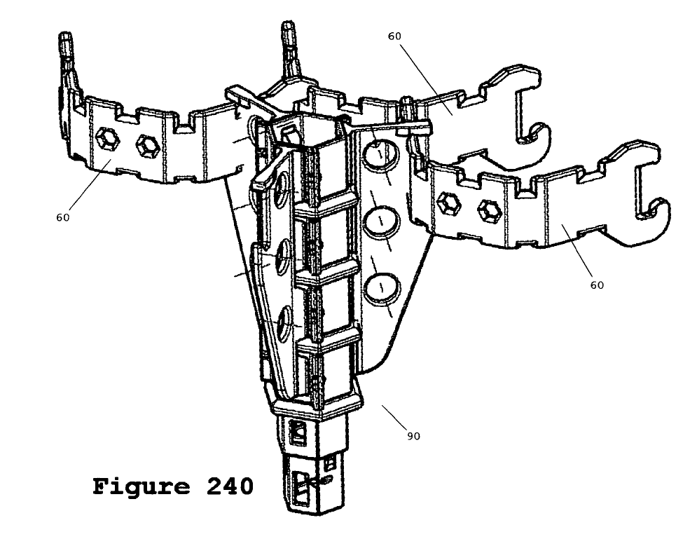

FIG. 230 is a perspective view of a complete leg assembly 90 about to be snapped into place on the honeycomb 116 in accordance with the invention. Notice the identified scoop 50 and stabilizer 48 in FIG. 230. There are two possible ways of attaching the complete leg assembly 90 to the three arm 60 elements. The first way, suggested in FIG. 230 and illustrated in FIG. 240, is to place the scoop 50 on two of the buttresses under each of the left hook lower groove 30 and the right hook lower groove 34, respectively, then push the corresponding stabilizer 48 on each of those two buttresses into the left hook upper groove 32 and right hook upper groove 36. The second way, is to place the scoop 50 of one of the buttresses on the complete leg assembly 90 under the spine lower groove 38, then push the corresponding stabilizer 48 on the buttress 62 into the spine upper groove 40 to hold the complete leg assembly 90 in place. This is not preferred because during assembly of the invention, it is easier to handle the assembly when two buttresses are attached to the honeycomb 116; that is, what the user of the invention has assembled so far is more stable when held in their hands.

FIG. 240 is a perspective view of a complete leg assembly 90 snapped into place on the honeycomb 116 in accordance with the invention. This illustration shows the complete leg assembly 90 in place after the action described in the previous paragraph is taken. Because all of the elements of the invention are made from HDPE (high-density polyethylene), the resulting structure is relatively flexible. The stabilizer 48, for example, freely bends to accommodate being pushed into place on the top of the arm 60, then returns to its position when in place.

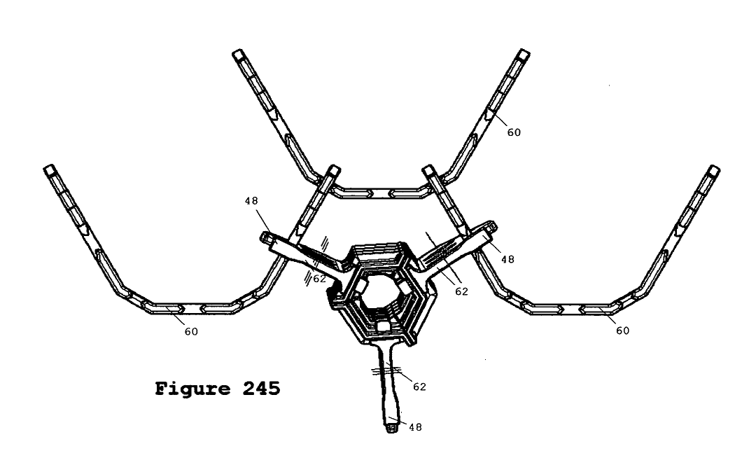

FIG. 245 is a top perspective view of a leg assembly 90 attached to a set of three assembled arm 60 elements in accordance with the invention. In practicality, when the user of the invention has assembled a honeycomb 116, there is a degree of skewing. That is, the honeycomb 116 can flex or bend, “warping” the shape of any or all individual hexagons within the honeycomb 116. The buttress 62 elements when attached to the leg assembly 90 are designed to allow a considerable degree of bending to line up with their corresponding connection points on the arm 60 elements. This is to facilitate both ease of assembly, where the elements need to bend a little to snap into place, and also, to provide more “give” in the entire structure to reduce the injury risk when a child or animal falls onto the honeycomb 116.

FIG. 250 is a top perspective view of three edge 70 elements snapped into place in each of three different possible ways on the honeycomb 116 in accordance with the invention. When a number of arm 60 elements are assembled together, at one side of the honeycomb 116 there are left and right sides of arm 60 elements pointing away from the honeycomb 116. The edge 70 piece can be snapped into place on almost any pair of such arm 60 sides. Edge-1 118 is an illustration of an edge 70 used to “pair-off” a pair of arm 60 ends pointing toward one another. Edge-2 120 is an illustration of an edge 70 used to pair-off two parallel arm 60 ends at right angles to the edge 70 element. Edge-3 122 is an illustration of an edge 70 used to pair-off two arm 60 ends that are parallel to each other, but are at an approximately 30 degree angle to the edge 70.

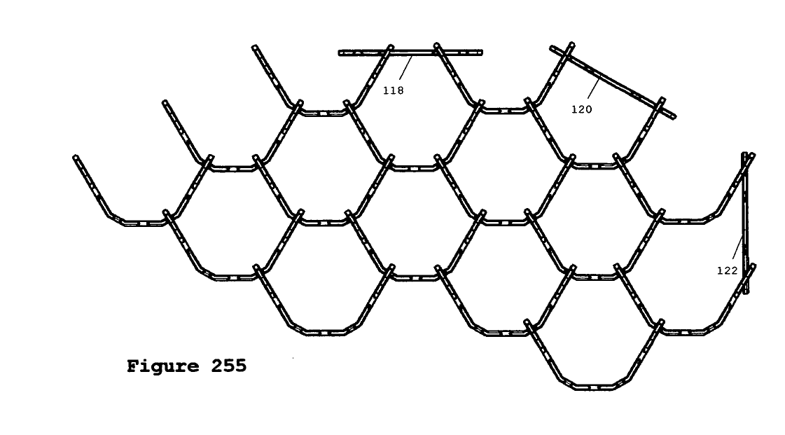

FIG. 255 is a top view of the view in FIG. 250, of three edge 70 elements snapped into place in each of three different possible ways on the honeycomb 116 in accordance with the invention.

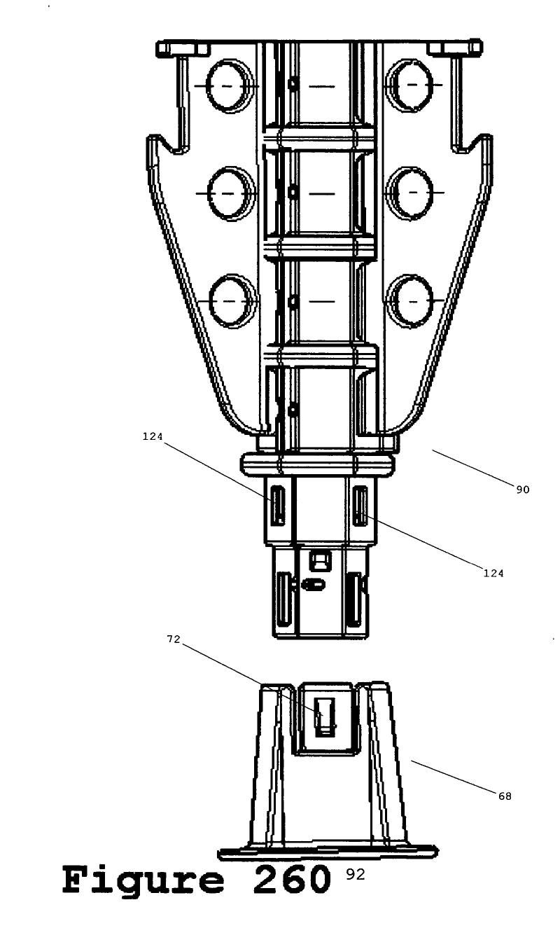

FIG. 260 is a front view of a foot 68 element before it is snapped into place on a completed leg assembly 90 in accordance with the invention. Each of the three finger 100 elements on the foot 68 slides over a side of the leg assembly 90 that has rectangular holes. The foot notch 72 on each finger 100 snaps into the second lowest hole 124 on the side of the leg assembly 90 it slides over. The user of the invention applies a modest amount of pressure to push the foot 68 element into place.

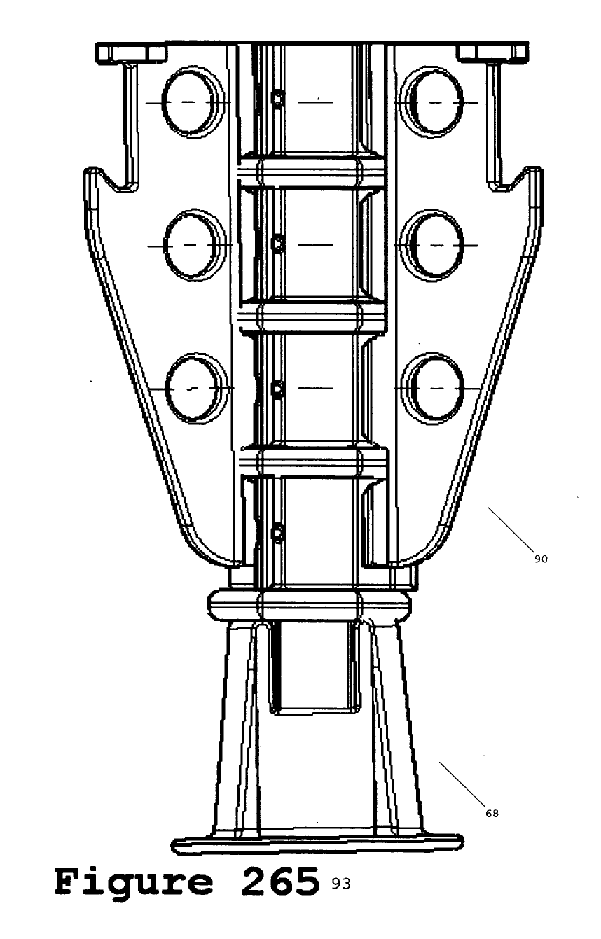

FIG. 265 is a front view of a foot 68 element snapped into place on a completed leg assembly 90 in accordance with the invention. The foot 68 element has been snapped into place. Once in place, the three foot notch 72 elements (not visible in FIG. 265, but very clearly visible in FIG. 90), hold the foot 68 in place as they stay inside the rectangular hole elements they snapped into.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A honeycomb-like structure barrier in a body of water for reducing the risks to children and fish, comprising:
means for forming hexagons that form a honeycomb-like structure;
means for attaching to a vertical leg to provide support to the honeycomb-like structure, firmly attached to said means for forming hexagons that form a honeycomb-like structure;
means for providing a support structure for the buttress, flexibly hooked to said means for attaching to a vertical leg to provide support to the honeycomb-like structure;
means for holding the leg section together, to make a reinforced leg section, lockingly connected to said means for providing a support structure for the buttress;
means for providing an upper and lower groove into which right hooks from another arm are snapped so that two arms remain attached to one another;
means for providing an upper and lower groove into which left hooks from another arm are snapped so that two arms remain attached to one another;
means for supporting the underside of the right shoulder of another arm;
means for holding the left lower hook in place;
means for supporting the underside of the left shoulder of another arm;
means for holding the right lower hook in place;
means for providing a fastening point for the right upper hook;
means for providing a fastening point for the right lower hook;
means for providing a fastening point for the left upper hook;
means for providing a fastening point for the left lower hook;
means for providing a smooth surface to spread the load of the downward pressure exerted by the leg assembly on the floor of the pond or body of water;
means for providing a barrier between a body of water beyond a few inches and the area above and around the body of water; and
means for providing the building block for the honeycomb.

2. The honeycomb-like structure barrier in a body of water in accordance with claim 1, wherein said means for forming hexagons that form a honeycomb-like structure comprises an arm, having a shape similar to three sides of a hexagon.

3. The honeycomb-like structure barrier in a body of water in accordance with claim 1, wherein said means for attaching to a vertical leg to provide support to the honeycomb-like structure comprises a vertical buttress.

4. The honeycomb-like structure barrier in a body of water in accordance with claim 1, wherein said means for providing a support structure for the buttress comprises an extensible, freeze tolerant leg.

5. The honeycomb-like structure barrier in a body of water in accordance with claim 1, wherein said means for holding the leg section together, to make a reinforced leg section comprises a ring.

6. The honeycomb-like structure barrier in a body of water in accordance with claim 1, wherein said means for supporting the underside of the right shoulder of another arm comprises a round left lower hook, having an opening to support Arm.

7. The honeycomb-like structure barrier in a body of water in accordance with claim 1, wherein said means for holding the left lower hook in place comprises a flexible left upper hook, having a lip to keep it snapped in place.

8. The honeycomb-like structure barrier in a body of water in accordance with claim 1, wherein said means for supporting the underside of the left shoulder of another arm comprises a round right lower hook, having an opening to support arm.

9. The honeycomb-like structure barrier in a body of water in accordance with claim 1, wherein said means for holding the right lower hook in place comprises a flexible right upper hook, having a lip to keep it in place.

10. The honeycomb-like structure barrier in a body of water in accordance with claim 1, wherein said means for providing a fastening point for the right upper hook comprises a smooth left shoulder upper groove, having an opening for a right upper hook.

11. The honeycomb-like structure barrier in a body of water in accordance with claim 1, wherein said means for providing a smooth surface to spread the load of the downward pressure exerted by the leg assembly on the floor of the pond or body of water comprises a rounded, flexible foot base.

12. The honeycomb-like structure barrier in a body of water in accordance with claim 1, wherein said means for providing a barrier between a body of water beyond a few inches and the area above and around the body of water comprises a honeycomb.

13. The honeycomb-like structure barrier in a body of water in accordance with claim 1, wherein said means for providing the building block for the honeycomb comprises a roughly six-sided hexagon.

14. A honeycomb-like structure barrier in a body of water for reducing the risks to children and fish, comprising:
an arm, having a shape similar to three sides of a hexagon, for forming hexagons that form a honeycomb-like structure;
a vertical buttress, for attaching to a vertical leg to provide support to the honeycomb-like structure, firmly attached to said arm;
an extensible, freeze tolerant leg, for providing a support structure for the buttress, flexibly hooked to said buttress;
a ring, for holding the leg section together, to make a reinforced leg section, lockingly connected to said leg;
a vertical left shoulder, for providing an upper and lower groove into which right hooks from another arm are snapped so that two arms remain attached to one another;
a vertical right shoulder, for providing an upper and lower groove into which left hooks from another arm are snapped so that two arms remain attached to one another;
a round left lower hook, having an opening to support Arm, for supporting the underside of the right shoulder of another arm;
a flexible left upper hook, having a lip to keep it snapped in place, for holding the left lower hook in place;
a round right lower hook, having an opening to support arm, for supporting the underside of the left shoulder of another arm;
a flexible right upper hook, having a lip to keep it in place, for holding the right lower hook in place;
a smooth left shoulder upper groove, having an opening for a right upper hook, for providing a fastening point for the right upper hook;
an opening for a right lower hook, smooth left shoulder lower groove, for providing a fastening point for the right lower hook;
an opening for a left upper hook, smooth right shoulder upper groove, for providing a fastening point for the left upper hook;
an opening for a left lower hook, smooth right shoulder lower groove, for providing a fastening point for the left lower hook;
a rounded, flexible foot base, for providing a smooth surface to spread the load of the downward pressure exerted by the leg assembly on the floor of the pond or body of water;
a honeycomb, for providing a barrier between a body of water beyond a few inches and the area above and around the body of water; and
a roughly six-sided hexagon, for providing the building block for the honeycomb.

15. The honeycomb-like structure barrier in a body of water as recited in claim 14, further comprising:
a smooth edge, for providing a finished look at the perimeter of the honeycomb, transversely connected to said arm.

16. The honeycomb-like structure barrier in a body of water as recited in claim 15, wherein said leg is flexible.

17. A honeycomb-like structure barrier in a body of water for reducing the risks to children and fish, comprising:
a flexible, plastic arm, having a shape similar to three sides of a hexagon, for forming hexagons that form a honeycomb-like structure;
a plastic, flexible, vertical buttress, for attaching to a vertical leg to provide support to the honeycomb-like structure, firmly attached to said arm;
an extensible, flexible, freeze tolerant leg, for providing a support structure for the buttress, flexibly hooked to said buttress;
a flexible, close fitting ring, for holding the leg section together, to make a reinforced leg section, lockingly connected to said leg;
a smooth edge, for providing a finished look at the perimeter of the honeycomb, transversely connected to said arm;
a vertical left shoulder, for providing an upper and lower groove into which right hooks from another arm are snapped so that two arms remain attached to one another;
a vertical right shoulder, for providing an upper and lower groove into which left hooks from another arm are snapped so that two arms remain attached to one another;
a round left lower hook, having an opening to support Arm, for supporting the underside of the right shoulder of another arm;
a flexible left upper hook, having a lip to keep it snapped in place, for holding the left lower hook in place;
a round right lower hook, having an opening to support arm, for supporting the underside of the left shoulder of another arm;
a flexible right upper hook, having a lip to keep it in place, for holding the right lower hook in place;
a smooth left shoulder upper groove, having an opening for a right upper hook, for providing a fastening point for the right upper hook;
an opening for a right lower hook, smooth left shoulder lower groove, for providing a fastening point for the right lower hook;
an opening for a left upper hook, smooth right shoulder upper groove, for providing a fastening point for the left upper hook;
an opening for a left lower hook, smooth right shoulder lower groove, for providing a fastening point for the left lower hook;
a rounded, flexible foot base, for providing a smooth surface to spread the load of the downward pressure exerted by the leg assembly on the floor of the pond or body of water;
a honeycomb, for providing a barrier between a body of water beyond a few inches and the area above and around the body of water; and
a roughly six-sided hexagon, for providing the building block for the honeycomb.
